(19) United States
(12) Patent Application Publication
(10) Pub. No.: US 2014/0200112 A1
(43) Pub. Date: Jul. 17, 2014

(54) CONTROL APPARATUS FOR VEHICLE

(71) Applicants: Takaaki TOKURA, Nagoya-shi (JP); Motonori KIMURA, Toyota-shi (JP)

(72) Inventors: Takaaki TOKURA, Nagoya-shi (JP); Motonori KIMURA, Toyota-shi (JP)

(73) Assignee: TOYOTA JIDOSHA KABUSHIKI KAISHA, Toyota-shi (JP)

(21) Appl. No.: 14/152,102

(22) Filed: Jan. 10, 2014

(30) Foreign Application Priority Data
Jan. 11, 2013 (JP) 2013-003929

(51) Int. Cl. B60W 10/107; B60W 10/04

(52) U.S. Cl. CPC B60W 10/107; B60W 10/04
USPC 477/37

(57) ABSTRACT

Disclosed is a control apparatus for a vehicle including: a belt continuously variable transmission capable of continuously changing a gear ratio; and a forward/reverse switching mechanism capable of controlling a state of power transmission between an engine and the belt continuously variable transmission. The control apparatus is configured to, at re-acceleration following deceleration, perform an input clutch slip control to place a forward clutch of the forward/reverse switching mechanism in a slipping engagement position and thus increase an engine revolution speed.

### CROSS-REFERENCE TO RELATED APPLICATIONS

This application claims priority under 35 USC 119(a) to Patent Application No. 2013-003929 filed in Japan on Jan. 11, 2013, the entire contents of which are incorporated herein by reference. The entire contents of Published Patent Application No. 2012-042037 filed in Japan on Aug. 23, 2010, are also incorporated herein by reference.

### BACKGROUND

1. Technical Field

The present invention relates to a control apparatus for a vehicle and particularly relates to a control apparatus for a vehicle that can improve the acceleration performance of the vehicle at re-acceleration following deceleration.

2. Related Art

Vehicles have conventionally employed a continuously variable transmission (CVT) capable of continuously changing the gear ratio in order to transmit engine power to the drive wheels. When a vehicle equipped with such a CVT stops, the CVT is generally controlled to return the gear ratio to the lowest-speed gear ratio (the maximum gear ratio) in preparation for a vehicle restart following the stop. However, when the vehicle is suddenly decelerated, the gear ratio may not be returned to the lowest-speed gear ratio before the stop. In the case of a CVT having a structure requiring the rotation of an output side rotating element in order to change the gear ratio, such as a belt CVT, a chain CVT or a half-toroidal CVT, if the vehicle stops as the gear ratio fails to be returned to the lowest-speed gear ratio in the above manner, it is difficult to change the gear ratio during the vehicle stop. Therefore, the acceleration performance at re-acceleration following deceleration (inclusive of a vehicle stop) will be degraded.

As an example of a solution to the above problem, Japanese Published Patent Application (JP-A) No. 2007-270629 discloses a technique in which when the gear ratio at a vehicle stop is not higher than a predetermined threshold value or the reduction ratio in the process of stopping the vehicle is not lower than a predetermined threshold value, the engine power is increased to improve the restartability after a sudden vehicle stop.

In the above technique disclosed in JP-A No. 2007-270629, the engine power is increased (a high engine torque is produced), such as by advancing the fuel injection timing, so that a driving force required by the driver is produced even when the gear ratio is not maximum. However, the producible engine torque level is generally known to be different depending upon the engine revolution speed. Specifically, it is known that the producible engine torque increases with increasing engine revolution speed, for example, from an idle revolution speed to a predetermined revolution speed and becomes maximal when the engine revolution speed reaches the predetermined revolution speed.

It is also generally known that even if, in a stall condition in which the output shaft of the torque converter is stopped, the throttle is fully opened, the engine revolution speed does not reach the predetermined revolution speed at which the maximum engine torque can be produced.

Therefore, in the technique disclosed in JP-A No. 2007-270629, depending upon how high the gear ratio at the greatest deceleration (inclusive of a vehicle stop) is and how large the driving force required by the driver is, the engine torque level necessary to produce the required driving force may exceed the engine torque level producible at an engine revolution speed at re-acceleration to make it difficult to produce the driving force required by the driver.

### SUMMARY

The present invention has been made in view of the foregoing points and therefore an object thereof is that in relation to a control apparatus for a vehicle, a technique is provided which can improve acceleration performance at re-acceleration following deceleration even when the gear ratio at the greatest deceleration is not the lowest-speed gear ratio.

The present invention is directed to a control apparatus for a vehicle including: a continuously variable transmission capable of continuously changing a gear ratio; and an engagement device capable of controlling a state of power transmission between an engine and the continuously variable transmission.

In an aspect of the present invention, the control apparatus is configured to, at re-acceleration following deceleration, perform a slip control to place the engagement device in a slipping engagement position and thus increase an engine revolution speed.

With this configuration, at re-acceleration following a vehicle deceleration (inclusive of a vehicle stop), such as owing to sudden braking, the engagement device between the engine and the continuously variable transmission is placed in a slipping engagement position to increase the engine revolution speed. Therefore, an engine torque higher than the engine torque producible with the engagement device in an engaged position can be produced. Because the vehicle driving force is proportional to the product of the engine torque and the gear ratio and since a high engine torque is produced by increasing the engine revolution speed, a driving force required by the driver can be produced even when the gear ratio is not the lowest-speed gear ratio (the maximum gear ratio). Thus, even when the gear ratio at the greatest deceleration is not the lowest-speed gear ratio, the acceleration performance at re-acceleration following deceleration can be improved.

Re-acceleration following deceleration includes the case where the driver requires a large driving force, such as at sudden acceleration, and the case where the driver requires only a small driving force. Therefore, depending upon how large the driving force required by the driver is, the driving force required by the driver may be achievable even by the engine revolution speed at the current time (before the slip control) and a gear ratio lower than the maximum gear ratio. It is undesirable to make a slip control also in this case, because it hastens the wear of engagement members of the engagement device.

To cope with this, the control apparatus is preferably configured to perform the slip control if a driving force required by a driver is unachievable by the gear ratio at re-acceleration and the engine revolution speed before the slip control.

With this configuration, only when the driving force required by the driver is unachievable by the current engine revolution speed and gear ratio, the control apparatus performs the slip control to increase the engine revolution speed. Therefore, it can be avoided that the slip control is unnecessarily performed.

Furthermore, the control apparatus is preferably configured to, when during the slip control an amount of heat generated by the engagement device reaches or exceeds a predetermined value, stop the slip control and place the engagement device in an engaged position.

Since, as just described, the slip control is stopped when during the slip control the amount of heat generated by the engagement device reaches or exceeds a predetermined value, the engagement device can be protected against overheating.

### BRIEF DESCRIPTION OF DRAWINGS

FIG. 1 is a schematic configuration diagram showing a power train according to an embodiment.

FIG. 2 is a block diagram showing an example of an architecture of a control system including an ECU.

FIG. 3 is a graph showing an example of a map for use in shift control of a belt CVT.

FIG. 4 is a graph showing an example of a map for use in belt clamping force control of the belt CVT.

FIG. 5 is an engine torque characteristic diagram showing the relationship between engine revolution speed and maximum producible engine torque.

FIG. 6 is a flowchart showing an example of an input clutch slip control.

### DETAILED DESCRIPTION

Hereinafter, a description will be given of an embodiment of the present invention with reference to the drawings. In this embodiment, a description will be given of the case where the present invention is applied to a vehicle equipped with a belt CVT (continuously variable transmission).

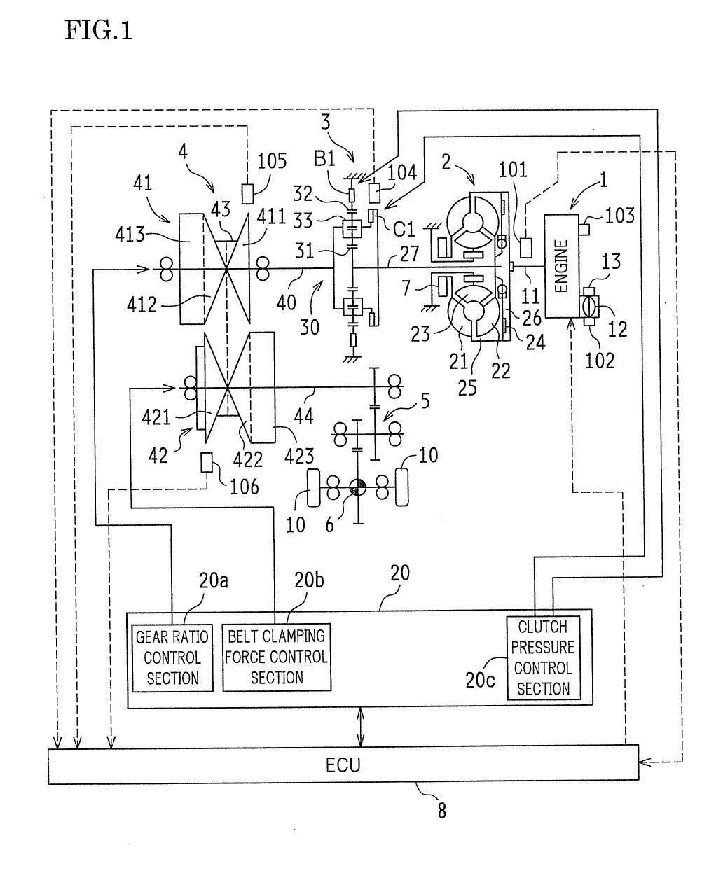

FIG. 1 is a schematic configuration diagram showing a power train according to this embodiment. As shown in FIG. 1, the power train includes an engine 1 as a driving power source, a torque converter 2 as a fluid drive mechanism, a forward/reverse switching mechanism 3, a belt CVT 4, a reduction gear mechanism 5, a differential gear mechanism 6, a hydraulic control circuit 20, and an ECU (electronic control unit) 8.

A crankshaft 11 serving as an output shaft of the engine 1 is coupled to the torque converter 2. The power output of the engine 1 is transmitted from the torque converter 2 through the forward/reverse switching mechanism 3, the belt CVT 4, and the reduction gear mechanism 5 to the differential gear mechanism 6 and then distributed to right and left drive wheels 10, 10. The following description is given of the details of the engine 1, the torque converter 2, the forward/reverse switching mechanism 3, the belt CVT 4, the hydraulic control circuit 20, and the ECU 8.

(Engine)

The engine 1 is, for example, a multi-cylinder gasoline engine. The volume of air to be taken in the engine 1 (intake air volume) is controlled by an electronically controlled throttle valve 12. The opening θth of the throttle valve 12, i.e., the throttle opening, can be electronically controlled independent of the driver's actuation of the accelerator pedal. The throttle opening θth can be detected by a throttle position sensor 102. The temperature Tw of cooling water for the engine 1 can be detected by a water temperature sensor 103.

The throttle valve 12 can be operationally controlled by the ECU 8 to adjust the throttle opening θth. Specifically, the ECU 8 controls the throttle opening θth of the throttle valve 12 to give an optimal intake air volume (target intake air volume) appropriate to the operating conditions of the engine 1, such as the engine revolution speed Ne detected by an engine speed sensor 101 and the amount of depression of the accelerator pedal (amount of actuation of the accelerator pedal; Acc) by the driver. More specifically, the ECU 8 detects the actual throttle opening θth of the throttle valve 12 using the throttle position sensor 102 and feedback-controls a throttle motor 13 for the throttle valve 12 so that the actual throttle opening θth agrees with the throttle opening capable of achieving the target intake air volume (target throttle opening).

(Torque Converter)

The torque converter 2 includes a pump impeller 21 at the input side, a turbine runner 22 at the output side, and a stator 23 capable of exhibiting the function of amplifying torque and performs power transmission via a fluid between the pump impeller 21 and the turbine runner 22. The pump impeller 21 is coupled to the crankshaft 11 of the engine 1. The turbine runner 22 is coupled through a turbine shaft 27 to the forward/reverse switching mechanism 3.

The torque converter 2 is provided with a lock-up clutch 24 capable of directly coupling between the input side and output side of the torque converter 2. The lock-up clutch 24 can be fully engaged, partly engaged (engaged in slipping conditions), or released by controlling the differential pressure (lock-up differential pressure) between the hydraulic pressure in an engaging chamber 25 of the lock-up clutch 24 and the hydraulic pressure in a releasing chamber 26 thereof.

When the lock-up clutch 24 is fully engaged, the pump impeller 21 and the turbine runner 22 rotate together. When the lock-up clutch 24 is engaged in a predetermined slipping condition (in a partly engaged position), the turbine runner 22, during operation, rotates while following, but with a predetermined amount of slip on, the pump impeller 21. On the other hand, when the lock-up differential pressure is set at a negative value, the lock-up clutch 24 is released.

Furthermore, the torque converter 2 is also provided with a mechanical oil pump 7 which is connected to and can be driven by the pump impeller 21.

(Forward/Reverse Switching Mechanism)

The forward/reverse switching mechanism (engagement device) 3 is configured to control the state of power transmission between the engine 1 and the belt CVT 4 and includes a double-pinion planetary gear set 30, a forward clutch C1, and a reverse brake B1.

A sun gear 31 of the planetary gear set 30 is integrally connected to the turbine shaft 27 of the torque converter 2 and a carrier 33 of the planetary gear set 30 is integrally connected to an input shaft 40 of the belt CVT 4. The carrier 33 and the sun gear 31 are selectively connected to each other through the forward clutch C1 and a ring gear 32 of the planetary gear set 30 is selectively fixed through the reverse brake B1 to a housing of the forward/reverse switching mechanism 3.

The forward clutch C1 is a wet, multiple disc, hydraulic friction engagement element including: a plurality of outer friction discs (not shown) connected to a clutch drum of a hydraulic actuator (not shown) connected to the turbine shaft 27; and a plurality of inner friction discs (not shown) connected to the carrier 33. In the forward clutch C1, when a hydraulic fluid is supplied to a hydraulic chamber of the hydraulic actuator by the oil pump 7, the outer friction discs are engaged with the inner friction discs, so that the carrier 33 and the sun gear 31 are connected. On the other hand, when the hydraulic fluid is discharged from the hydraulic chamber of the hydraulic actuator, the outer friction discs are disengaged from the inner friction discs, so that the connection between the carrier 33 and the sun gear 31 are released.

The reverse brake B1 is a wet, multiple disc, hydraulic friction engagement element including: a plurality of outer friction discs (not shown) attached to the housing; and a plurality of inner friction discs (not shown) connected to the ring gear 32. In the reverse brake B1, when a hydraulic fluid is supplied to a hydraulic chamber of a hydraulic actuator (not shown) by the oil pump 7, the outer friction discs are engaged with the inner friction discs, so that the rotation of the ring gear 32 is restricted. On the other hand, when the hydraulic fluid is discharged from the hydraulic chamber of the hydraulic actuator, the outer friction discs are disengaged from the inner friction discs, so that the rotation of the ring gear 32 is permitted.

Each of the forward clutch C1 and the reverse brake B1 is engaged and released by the hydraulic control circuit 20. When the forward clutch C1 is engaged by supplying, to the hydraulic actuator, the hydraulic fluid with its hydraulic pressure level reaching a full engagement pressure and the reverse brake B1 is released, the forward/reverse switching mechanism 3 rotates in its entirety (is fully engaged) to establish a forward power transmission path. In this state, a forward driving force is transmitted toward the belt CVT 4.

When the forward clutch C1 is engaged in a slipping condition by supplying, to the forward clutch C1, the hydraulic fluid with its hydraulic pressure level below the full engagement pressure and the reverse brake B1 is released, the forward/reverse switching mechanism 3 is placed in a slipping engagement position to establish a forward power transmission path. In this state, part of the driving force output from the engine 1 is converted into heat and the remaining forward driving force is transmitted toward the belt CVT 4. In this case, since the forward clutch C1 is slipping, the input shaft 40 of the belt CVT 4 rotates the amount of slip later than the turbine shaft 27 of the torque converter 2 and transmits power the amount of slip smaller than the turbine shaft 27.

On the other hand, when the reverse brake B1 is engaged and the forward clutch C1 is released, the forward/reverse switching mechanism 3 establishes (achieves) a reverse power transmission path. In this state, the input shaft 40 rotates reversely to the turbine shaft 27 and a reverse driving force thus produced is transmitted toward the belt CVT 4. When both the forward clutch C1 and the reverse brake B1 are released, the forward/reverse switching mechanism 3 is placed in a neutral position (an interrupted position) in which power transmission is interrupted.

(Belt CVT)

The belt CVT 4 is configured to receive power from the engine 1, change the revolution speed of the input shaft 40, and then transmit the power toward the drive wheels 10, 10. The belt CVT 4 includes a primary pulley 41 at the input side, a secondary pulley 42 at the output side, and a belt 43 made of metal and mounted around the primary pulley 41 and the secondary pulley 42.

The primary pulley 41 is a variable pulley capable of varying its effective diameter and is composed of a fixed sheave 411 fixed to the input shaft 40 and a movable sheave 412 disposed on the input shaft 40 in a manner capable of slide movement thereon only in an axial direction of the input shaft 40. The secondary pulley 42 is also a variable pulley capable of varying its effective diameter and is composed of a fixed sheave 421 fixed to an output shaft 44 of the CVT 4 and a movable sheave 422 disposed on the output shaft 44 in a manner capable of slide movement thereon only in an axial direction of the output shaft 44.

A hydraulic actuator 413 is disposed next to the movable sheave 412 of the primary pulley 41 and serves to change the width of a V-groove formed between the fixed sheave 411 and the movable sheave 412. Likewise, a hydraulic actuator 423 is disposed next to the movable sheave 422 of the secondary pulley 42 and serves to change the width of a V-groove formed between the fixed sheave 421 and the movable sheave 422.

In the belt CVT 4 having the above structure, by the control of the hydraulic pressure of the hydraulic actuator 413 for the primary pulley 41, the widths of the V-grooves of the primary pulley 41 and the secondary pulley 42 are changed to change the winding diameter (effective diameter) of the belt 43. Thus, the gear ratio γ (γ=(primary pulley revolution speed (input shaft revolution speed) Nin)/(secondary pulley revolution speed (output shaft revolution speed) Nout)) continuously changes. Furthermore, the hydraulic pressure of the hydraulic actuator 423 for the secondary pulley 42 is controlled so that the belt 43 can be clamped with a predetermined clamping force with which no belt slip will occur. These hydraulic pressure controls are effected by the ECU 8 and the hydraulic control circuit 20.

(Hydraulic Control Circuit)

Although not shown in detail, the hydraulic control circuit 20 includes: a gear ratio control section 20a including a solenoid valve for shift control; a belt clamping force control section 20b including a linear solenoid valve for belt clamping force control; and a clutch pressure control section 20c including a linear solenoid valve. The hydraulic control circuit 20 further includes a linear solenoid valve for the control of line pressure and a duty solenoid valve for the control of lock-up engagement pressure.

The solenoid valves receive control signals from the ECU 8. Thus, the gear ratio control section 20a and the belt clamping force control section 20b of the hydraulic control circuit 20 control the hydraulic actuators 413, 423 of the belt CVT 4, so that a shift control and a belt clamping force control, both to be described later, are executed. Furthermore, operation controls of the lock-up clutch 24 of the torque converter 2 and the forward/reverse switching mechanism 3 are also executed, likewise, according to control signals from the ECU 8.

(ECU)

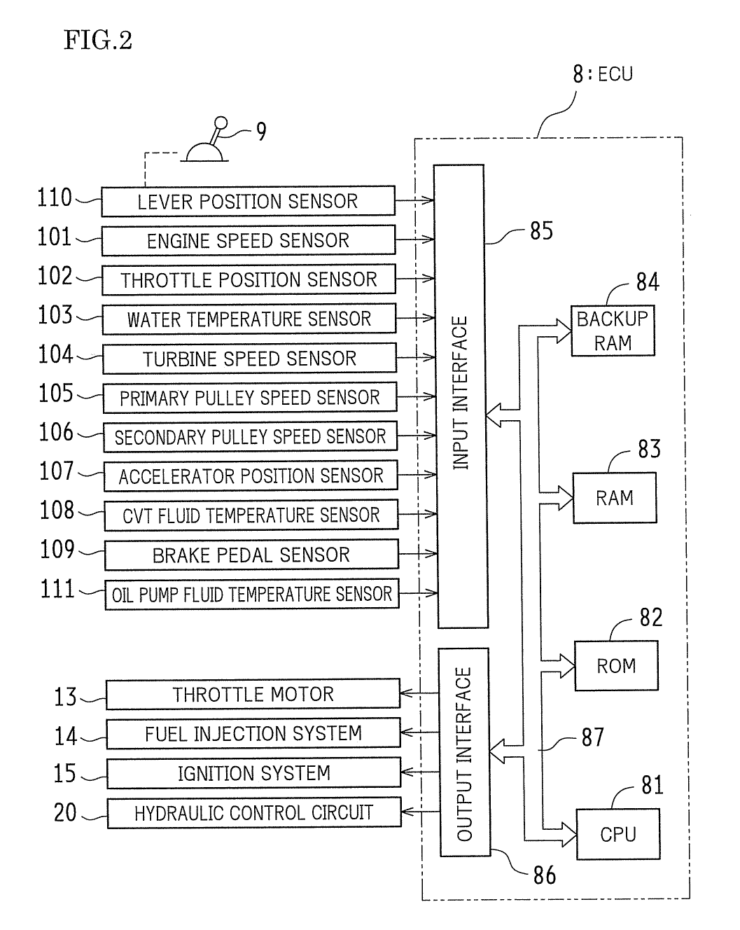

The ECU (control apparatus) 8, as shown in FIG. 2, includes a CPU (central processing unit) 81, the ROM (read-only memory) 82, a RAM (random access memory) 83, a backup RAM 84, and so on. The ROM 82 stores various control programs and maps that will be referred to in running the control programs. The CPU 81 performs processings based on the various control programs and maps stored in the ROM 82. The RAM 83 is a memory capable of temporarily storing calculation results in the CPU 81 and data input from sensors. The backup RAM 84 is a non-volatile memory capable of storing data to be saved upon shutdown of the engine 1. The CPU 81, the ROM 82, the RAM 83, and the backup RAM 84 are connected via a bus 87 to each other, an input interface 85, and an output interface 86.

The input interface 85 of the ECU 8 is connected to the engine speed sensor 101, the throttle position sensor 102, the water temperature sensor 103, a turbine speed sensor 104, a primary pulley speed sensor 105, a secondary pulley speed sensor 106, an accelerator position sensor 107, a CVT fluid temperature sensor 108, a brake pedal sensor 109, a lever position sensor 110 configured to detect the lever position (operation position) of a shift lever 9, an oil pump fluid temperature sensor 111, and so on. The ECU 8 is given output signals from these sensors, i.e., signals indicating the revolution speed Ne of the engine 1 (engine revolution speed), the throttle opening θth of the throttle valve 12, the temperature Tw of cooling water in the engine 1, the revolution speed Nt of the turbine shaft 27 (turbine revolution speed), the primary pulley revolution speed (input shaft revolution speed) Nin, the secondary pulley revolution speed (output shaft revolution speed) Nout, the amount Acc of actuation of the accelerator pedal (accelerator opening), the fluid temperature The in the hydraulic control circuit 20 (CVT fluid temperature), whether or not a foot brake as a service brake has been actuated (brake ON/OFF), the lever position (operation position) of the shift lever 9, and the fluid temperature Tho in the oil pump 7 (oil pump fluid temperature).

Among the various types of signals to be given to the ECU 8, the turbine revolution speed Nt agrees with the primary pulley revolution speed (input shaft revolution speed) Nin during forward travel in which the forward clutch C1 of the forward/reverse switching mechanism 3 is engaged, and the secondary pulley revolution speed (output shaft revolution speed) Nout is associated with the vehicle speed V during forward travel. Furthermore, the amount Acc of accelerator pedal actuation represents the amount of power output required by the driver.

The shift lever 9 can be selectively operated into several positions, including a parking position “P” for parking, a reverse position “R” for reverse travel, a neutral position “N” for interrupting power transmission, a drive position “D” for forward travel, and a manual position “M” where the gear ratio γ of the belt CVT 4 can be manually increased and reduced during forward travel.

The manual position “M” is provided with downshift and upshift positions for increasing and reducing the gear ratio γ or provided with a plurality of range positions in which the driver can select any one of different shift ranges having different highest speeds (lowest gear ratios γ).

The lever position sensor 110 includes a plurality of ON/OFF switches which serve to detect that the shift lever 9 has been operated into, for example, the parking position “P”, the reverse position “R”, the neutral position “N”, the drive position “D”, the manual position “M”, the upshift position, the downshift position or each of the range positions. In order to manually change the gear ratio γ, besides the shift lever 9, a downshift switch or lever and an upshift switch or lever may be provided, for example, on a steering wheel.

The output interface 86 of the ECU 8 is connected to the throttle motor 13, a fuel injection system 14, an ignition system 15, the hydraulic control circuit 20, and so on. The ECU 8 performs, based on the output signals from the aforementioned various types of sensors, the power output control of the engine 1, the shift control and belt clamping force control of the belt CVT 4, the engagement/release control of the lock-up clutch 24, the engagement/release control of the forward clutch C1 and the reverse brake B1, and so on. For example, in relation to the control of the engine 1, control signals are output to the throttle motor 13, the fuel injection system 14, and the ignition system 15 for the control of the intake air volume, the amount of fuel injected, and the ignition timing, respectively.

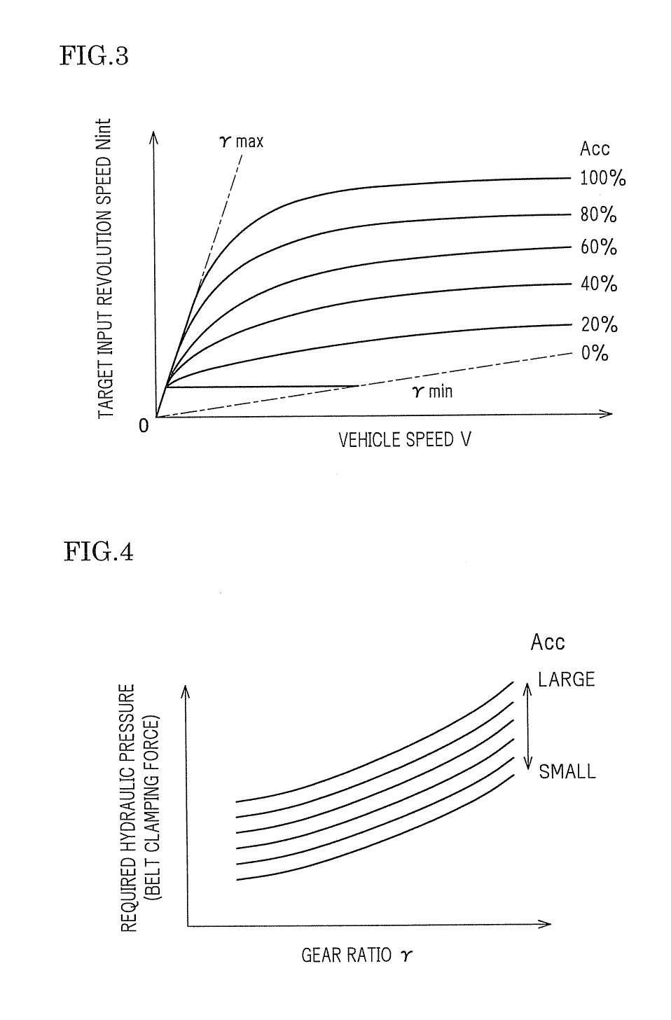

Furthermore, in relation to the control of the belt CVT 4, as shown by way of example in FIG. 3, the ECU 8 calculates a target input revolution speed Nint from a shift map previously set with the amount Acc of accelerator pedal actuation representing the amount of power output required by the driver and the vehicle speed V as parameters and performs the shift control of the belt CVT 4 according to the deviation (Nint−Nin) of the actual input shaft revolution speed Nin from the target input revolution speed Nint, i.e., so that the actual input shaft revolution speed Nin agrees with the target input revolution speed Nint. Specifically, the ECU 8 controls the shift control pressure according to the deviation (Nint−Nin) by supplying or discharging the working fluid to or from the hydraulic actuator 413 for the primary pulley 41, thus continuously changing the gear ratio γ. The map shown in FIG. 3 corresponds to shift conditions of the vehicle and is stored in the ROM 82 of the ECU 8.

In the map of FIG. 3, the target input revolution speed Nint is set so that the gear ratio γ becomes higher, the lower is the vehicle speed V and the larger is the amount Acc of accelerator pedal actuation. Therefore, in the belt CVT 4 of this embodiment, at a vehicle stop in which the vehicle speed is at zero, a shift control is made to return the gear ratio γ to the lowest-speed gear ratio (the maximum gear ratio γmax). By returning the gear ratio γ at a vehicle stop to the maximum gear ratio γmax, it is possible to reduce lack of driving force at a restart following the vehicle stop. Furthermore, because the vehicle speed V is associated with the secondary pulley revolution speed (output shaft revolution speed) Nout, the target input revolution speed Nint as the target value of the primary pulley revolution speed (input shaft revolution speed) Nin is associated with the target gear ratio and is set within the range from the minimum gear ratio γmin to the maximum gear ratio γmax of the belt CVT 4.

Moreover, the ECU 8 controls the belt clamping force control section 20b of the hydraulic control circuit 20 according to a map of belt clamping force control shown by way of example in FIG. 4. Specifically, the ECU 8 controls the control hydraulic pressure to be output from the linear solenoid according to a map of required hydraulic pressure (corresponding to the belt clamping force) previously set, with the amount Acc of accelerator pedal actuation corresponding to the transmission torque and the gear ratio γ (γ=Nin/Nout) as parameters, to avoid the occurrence of belt slip. Thus, the ECU 8 adjusts and controls the belt clamping force of the belt CVT 4, i.e., the hydraulic pressure of the hydraulic actuator 423 for the secondary pulley 42. The map shown in FIG. 4 corresponds to clamping force control conditions and is stored in the ROM 82 of the ECU 8.

(Control of Re-Acceleration Following Sudden Deceleration Using ECU and Hydraulic Control Circuit)

As described previously, when a vehicle equipped with the belt CVT 4 stops, the CVT 4 is generally controlled to return the gear ratio γ to the lowest-speed gear ratio in preparation for a vehicle restart following the stop. However, when the vehicle is suddenly decelerated, such as owing to sudden braking, the gear ratio γ may not be returned to the lowest-speed gear ratio before the stop, because of incomplete return of the belt 43. In the case of the belt CVT 4 having a structure requiring the rotation of the secondary pulley 42 in order to change the gear ratio γ, if the vehicle stops as the gear ratio γ fails to be returned to the lowest-speed gear ratio in the above manner, it is difficult to change the gear ratio γ during the vehicle stop. This may make it difficult to achieve a driving force F required by the driver (hereinafter, also referred to as a driver-required driving force F) at re-acceleration following deceleration.

As a solution to the above problem, it is conceivable that since the vehicle driving force is proportional to the product of the engine torque and the gear ratio, the engine power is increased, such as by advancing the fuel injection timing of the fuel injection system 14, to supplement the gear ratio γ lower than the maximum gear ratio γmax, resulting in achievement of the driver-required driving force F at re-acceleration following deceleration.

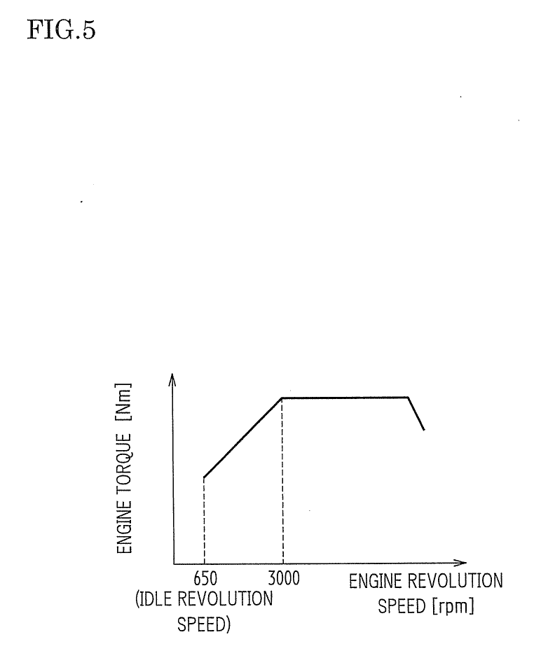

However, the producible engine torque level is generally known to be different depending upon the engine revolution speed Ne, as shown by way of example in FIG. 5. Specifically, in the example of FIG. 5, the engine torque increases with increasing engine revolution speed Ne from 650 rpm (an idle revolution speed) to 3000 rpm (a predetermined revolution speed), becomes maximal at an engine revolution speed Ne of 3000 rpm, is held at the maximum producible engine torque for a while after 3000 rpm, even at higher engine revolution speeds Ne, and then decreases when the engine revolution speed Ne becomes excessively high.

On the other hand, when the vehicle stops, such as owing to sudden braking, the rotations of the right and left drive wheels 10, 10, the differential gear mechanism 6, the reduction gear mechanism 5, the belt CVT 4, the forward/reverse switching mechanism 3, and the turbine shaft 27 of the torque converter 2 stop. Generally, in such a stall condition in which the revolution speed of the turbine shaft 27 of the torque converter 2 is at 0 rpm, even if the throttle valve 12 is fully opened, the engine revolution speed Ne is increased only to about 2000 rpm.

Therefore, for example, in the control method in which the engine power is increased by advancing the fuel injection timing of the fuel injection system 14, depending upon how high the gear ratio γ at a vehicle stop is and how large the driver-required driving force F is, the engine torque level necessary to produce the required driving force F may exceed the engine torque level producible at an engine revolution speed Ne at re-acceleration to make it difficult to produce the driver-required driving force F.

To cope with this, in this embodiment, at re-acceleration following deceleration, the engagement between the belt CVT 4 and the engine 1 is made looser to facilitate the increase of the engine revolution speed Ne. Specifically, the ECU 8 is configured to, at re-acceleration following deceleration, perform an input clutch slip control to output a control signal to the clutch pressure control section 20c and allow the clutch pressure control section 20c to place the forward clutch C1 of the forward/reverse switching mechanism 3 in a slipping engagement position, thus increasing the engine revolution speed Ne.

As just described, at re-acceleration following a vehicle deceleration (inclusive of a vehicle stop), the forward/reverse switching mechanism 3 is placed in a slipping engagement position to increase the engine revolution speed Ne. Therefore, an engine torque higher than the engine torque producible with the forward/reverse switching mechanism 3 in an engaged position can be produced. Since a high engine torque is produced by increasing the engine revolution speed Ne, a driver-required driving force F can be achieved even when the gear ratio γ is not the maximum gear ratio γmax. In the description hereinafter, the term “current gear ratio γ” refers to a gear ratio γ not yet returned to the lowest-speed gear ratio in a period from a vehicle stop or the greatest deceleration until a re-acceleration and the term “current engine revolution speed Ne” refers to an engine revolution speed Ne at the re-acceleration and before the input clutch slip control.

If the input clutch slip control is performed even when the driver-required driving force F can be achieved by an engine torque producible at the engine revolution speed Ne before the input clutch slip control and a gear ratio γ smaller than the maximum gear ratio γ, this is undesirable because it hastens the wear of the friction discs of the forward/reverse switching mechanism 3. To cope with this, the ECU 8 is configured to perform the input clutch slip control if the driver-required driving force F is unachievable by the gear ratio γ at re-acceleration and the engine revolution speed Ne before the input clutch slip control. More specifically, the ECU 8 is configured to calculate the maximum engine torque Tmax producible at the current engine revolution speed Ne and the engine torque Te necessary to produce the driver-required driving force F at the gear ratio γ at re-acceleration, and perform the input clutch slip control if the necessary engine torque Te is higher than the maximum engine torque Tmax. Thus, it can be avoided that the input clutch slip control is unnecessarily performed.

As described previously, in the slipping engagement position, part of the driving force output from the engine 1 is converted into heat, that is, the friction discs of the forward clutch C1 produce heat. Therefore, the forward/reverse switching mechanism 3 should be protected against overheating. To this end, the ECU 8 is configured to, when during the input clutch slip control the amount Q of heat generated by the forward/reverse switching mechanism 3 reaches or exceeds a predetermined amount Qa of heat generated, stop the input clutch slip control and place the forward/reverse switching mechanism 3 in an engaged position. Thus, the forward/reverse switching mechanism 3 can be protected against overheating.

To detect the amount Q of heat generated by the forward clutch C1, it is desirable to use a temperature sensor or the like disposed near the forward clutch C1. However, in this embodiment, the amount Q of heat generated by the forward clutch C1 is acquired by detecting, with the oil pump fluid temperature sensor 111, the fluid temperature (oil pump fluid temperature Tho) in the oil pump 7 supplying a hydraulic fluid to the forward clutch C1 and calculating, based on the detected oil pump fluid temperature Tho, the amount Q of heat generated by the forward clutch C1. The amount Q of heat generated for use in a determination to be described later may be an amount of heat generated per unit time or a cumulative amount of heat generated from the start of the input clutch slip control. When the amount of heat generated per unit time reaches or exceeds a predetermined amount of heat generated per unit time and/or when the cumulative amount of heat generated from the start of the input clutch slip control reaches or exceeds a predetermined cumulative amount of heat generated, the input clutch slip control may be stopped.

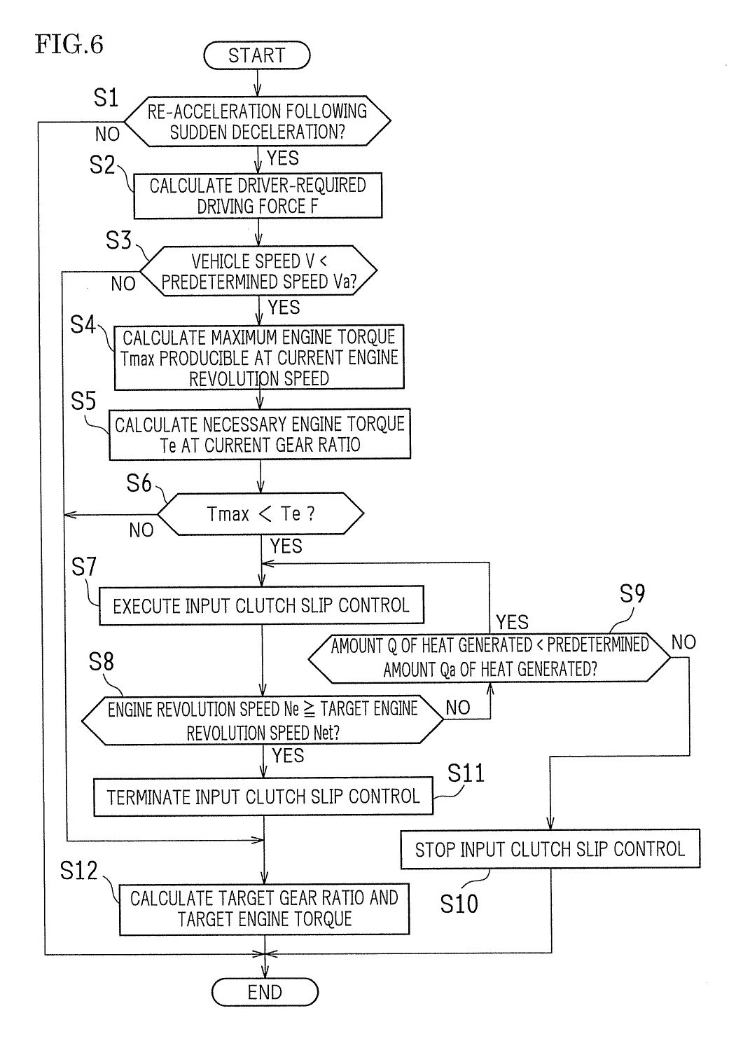

Next, an example of the control of re-acceleration following sudden deceleration in this embodiment will be described below with reference to the flowchart of FIG. 6.

First, in step S1, the ECU 8 determines whether or not the status of the vehicle corresponds to re-acceleration following sudden deceleration, based on the secondary pulley revolution speed Nout input from the secondary pulley speed sensor 106 and corresponding to the vehicle speed V, a signal input from the brake pedal sensor 109 and indicating whether or not the foot brake has been actuated, the amount Acc of actuation of the accelerator pedal input from the accelerator position sensor 107, and so on. If the determination in step S1 is NO, this means that the vehicle status is not associated with a degradation in acceleration performance due to incomplete return of the belt 43. Therefore, the process ends. On the other hand, if the determination in step S1 is YES, it is likely that, because of incomplete return of the belt 43, the gear ratio γ has not yet been returned to the lowest-speed gear ratio (not yet reached the maximum gear ratio γmax). Therefore, the ECU proceeds to step S2.

In step S2, the ECU 8 calculates the driver-required driving force F based on the amount of drive represented, such as by the amount Acc of actuation of the accelerator pedal, and the vehicle speed V (secondary pulley revolution speed Nout) and then proceeds to step S3.

In step S3, the ECU 8 determines whether or not the vehicle speed V at re-acceleration is lower than a predetermined value Va (for example, 1 km/h). If the determination in step S3 is NO, that is, if the vehicle is not close to a stop, it is likely that the belt 43 does not lead to incomplete return. Therefore, the ECU 8 proceeds to step S12. In step S12, the ECU 8 calculates a target gear ratio and a target engine torque which correspond to the required driving force F calculated in step S2.

On the other hand, if the determination is step S3 is YES, that is, if the vehicle speed V at re-acceleration is lower than, for example, 1 km/h, this means that the vehicle is stopping or close to a stop and the gear ratio γ is highly likely to be below the maximum gear ratio γmax because of incomplete return of the belt 43. Therefore, the ECU 8 proceeds to step S4.

In step S4, the ECU 8 calculates the maximum engine torque Tmax producible at the current engine revolution speed Ne and then proceeds to step S5. The maximum engine torque Tmax can be calculated based on the current engine revolution speed Ne or the like with reference to a map stored in the ROM 82 of the ECU 8 and relating to an engine torque characteristic, for example, as shown in FIG. 5.

In step S5, the ECU 8 calculates, according to the rate of the current gear ratio γ to the maximum gear ratio γmax, a necessary engine torque Te necessary to produce the driver-required driving force F at the current gear ratio γ and then proceeds to step S6. The current gear ratio γ can be calculated based on, for example, the primary pulley revolution speed Nin and the secondary pulley revolution speed Nout detected by the primary pulley speed sensor 105 and the secondary pulley speed sensor 106, respectively, just before the vehicle stops or reaches the greatest deceleration.

In step S6, the ECU 8 determines whether or not the necessary engine torque Te is higher than the maximum engine torque Tmax. If the determination in step S6 is NO, that is, if the driver-required driving force F can be produced by the maximum engine torque Tmax producible at the current engine revolution speed Ne, the ECU 8 proceeds to step S12 to calculate the target gear ratio and target engine torque corresponding to the required driving force F and then ends the process. On the other hand, if the determination in step S6 is YES, that is, if the driver-required driving force F is difficult to produce by the maximum engine torque Tmax producible at the current engine revolution speed Ne, the ECU 8 proceeds to step S7.

In step S7, the ECU 8 performs the input clutch slip control to output a control signal to the clutch pressure control section 20c and allow the clutch pressure control section 20c to place the forward clutch C1 of the forward/reverse switching mechanism 3 in a slipping engagement position and then proceeds to step S8. In this manner, the engagement between the belt CVT 4 and the engine 1 falling into a rotation stop or close to a rotation stop is made looser, which facilitates the increase of the engine revolution speed Ne and thus enables the production of an engine torque higher than the maximum engine torque Tmax producible at the current engine revolution speed Ne.

In step S8, the ECU 8 determines whether or not the engine revolution speed Ne increased by the input clutch slip control reaches or exceeds a target engine revolution speed Net. The target engine revolution speed Net can be calculated based on the necessary engine torque Te calculated in step S5, with reference to the map stored in the ROM 82 of the ECU 8 and relating to the engine torque characteristic, for example, as shown in FIG. 5. If the determination in step S8 is NO, that is, if the driver-required driving force F is still difficult to achieve by the engine torque producible at the increasing engine revolution speed Ne, the ECU 8 proceeds to step S9.

In step S9, the ECU 8 determines whether or not the amount Q of heat generated by the forward clutch C1, which has been calculated based on the oil pump fluid temperature Tho detected by the oil pump fluid temperature sensor 111, is smaller than the predetermined amount Qa of heat generated. If the determination in step S9 is NO, that is, if the amount Q of heat generated by the forward clutch C1 is not smaller than the predetermined amount Qa of heat generated, the ECU 8 proceeds to step S10 for the protection of the forward/reverse switching mechanism 3. The ECU 8 in step S10 stops the input clutch slip control and places the forward clutch C1 in an engaged position (a fully engaged position) and then the ECU 8 ends the process. On the other hand, if the determination in S9 is YES, the ECU 8 returns to step S7 to continue the input clutch slip control and proceeds again to step S8 to determine whether or not the engine revolution speed Ne increased by the input clutch slip control reaches or exceeds the target engine revolution speed Net.

If the determination in step S8 is YES, that is, if the engine revolution speed Ne reaches or exceeds the target engine revolution speed Net, the ECU 8 proceeds to step S11 to terminate the input clutch slip control and place the forward clutch C 1 in an engaged position and then proceeds to step S12. The ECU 8 in step S12 calculates the target gear ratio and target engine torque corresponding to the required driving force F and then ends the process.

As seen from the above, in the control apparatus for a vehicle according to this embodiment, while an unnecessary execution of the input clutch slip control can be avoided and the forward/reverse switching mechanism 3 can be protected against overheating, the engine revolution speed Ne can be increased at re-acceleration following a vehicle deceleration by placing the forward/reverse switching mechanism 3 in a slipping engagement position. Therefore, even if, because of incomplete return of the belt 43, the gear ratio γ does not reach the lowest-speed gear ratio, the driver-required driving force can be produced to improve the acceleration performance at re-acceleration following deceleration.

### Other Embodiments

While a single preferred embodiment of the present invention has thus far been described in detail with reference to the drawings, the embodiment is merely illustrative. The present invention can be implemented in any of a variety of forms in which modifications and improvements are made based on knowledge of those skilled in the art.

In the above embodiment, the input clutch slip control is performed when the necessary engine torque Te is higher than the maximum engine torque Tmax. However, the present invention is not limited to this. For example, when the target engine revolution speed Net is higher than the engine revolution speed Ne producible with the forward clutch C1 in an engaged position, the input clutch slip control may be performed.

In the above embodiment, the input clutch slip control is terminated when the engine revolution speed Ne increased by the input clutch slip control reaches or exceeds a target engine revolution speed Net. However, the present invention is not limited to this. For example, the input clutch slip control may be terminated when the turbine revolution speed Nt or the difference between the turbine revolution speed Nt and the primary pulley revolution speed Nin (slipping revolution speed) reaches or exceeds their respective target values calculated by the necessary engine torque Te.

In the above embodiment, the amount Q of heat generated by the forward clutch C1 is acquired based on the oil pump fluid temperature Tho. However, the present invention is not limited to this. For example, the amount Q of heat generated by the forward clutch C1 may be acquired from the duration time of the slipping engagement position.

In the above embodiment, the present invention is applied to the vehicle equipped with the belt CVT 4. However, the present invention is not limited to this. For example, the present invention may be applied to a vehicle equipped with a chain CVT or a toroidal CVT.

The aforementioned plurality of embodiments can be implemented in any combination, such as by assigning priorities.

Although not illustrated by examples, the present invention can be implemented by making various modifications without departing from the spirit of the present invention.

What is claimed is:

1. A control apparatus for a vehicle including:
a continuously variable transmission capable of continuously changing a gear ratio; and
an engagement device capable of controlling a state of power transmission between an engine and the continuously variable transmission,
wherein the control apparatus is configured to, at re-acceleration following deceleration, perform a slip control to place the engagement device in a slipping engagement position and thus increase an engine revolution speed.

2. The control apparatus for a vehicle according to claim 1, wherein the control apparatus is configured to perform the slip control if a driving force required by a driver is unachievable by the gear ratio at re-acceleration and the engine revolution speed before the slip control.

3. The control apparatus for a vehicle according to claim 1, wherein the control apparatus is configured to, when during the slip control an amount of heat generated by the engagement device reaches or exceeds a predetermined value, stop the slip control and place the engagement device in an engaged position.
